(19) United States
(12) Patent Application Publication
(10) Pub. No.: US 2009/0090463 A1
(43) Pub. Date: Apr. 9, 2009

(54) PATTERN FORMING METHOD AND METHOD FOR FORMING MULTILAYER WIRING STRUCTURE

(75) Inventor: Koichi Kawamura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/915,071

(22) PCT Filed: May 19, 2006
(86) PCT No.: PCT/JP2006/310029

§ 371 Date: Nov. 20, 2007

(30) Foreign Application Priority Data
May 20, 2005 (JP) 2005-148404

(51) Int. Cl. B32B 38/04; B05D 5/12

(52) U.S. Cl. 156/250; 427/118

(57) ABSTRACT

One embodiment of the present invention is a pattern forming method including: (I) a graft polymer forming step of preparing a substrate whose surface is modified with a graft polymer directly chemically bonded to a base material; (II) a particle-dispersed liquid placing step of placing droplets including a dispersion liquid including a liquid (dispersion medium) and particles dispersed therein on the graft polymer-formed surface in a predetermined pattern by a droplet discharging method; and (III) a particle pattern forming step of evaporating the liquid (dispersion medium) from the droplets placed, to form a layer including particles on the substrate in a predetermined pattern.

### TECHNICAL FIELD

The present invention relates to a pattern forming method by a droplet discharging method and a method for forming a multilayer wiring structure using the same. More particularly, the present invention relates to a method for forming a film pattern comprising placing particles having various functions on a substrate in a pattern, and a method for forming a multilayer wiring structure useful for the formation of conductive film wirings, electro-optic devices, electronic devices, non-contact card media, thin film transistors and the like.

### BACKGROUND ART

Methods of placing various functional materials on a solid surface in a predetermined pattern to locally give functionality are the subject of current research. A method of placing a conductive material on a solid surface to form a wiring or an electrode, having high resolution stands out in particular.

For example, the lithography method is used in the production of wiring used in electronic circuits or integrated circuits. However, the lithography method requires large-scale facilities such as vacuum apparatus, and complicated steps. Additionally, the material use efficiency is limited to only a few percent, and almost all of the conductive materials have to be disposed as waste, resulting in high production costs.

In view of the above, a method of directly patterning a liquid containing a functional material on a substrate by ink jet is being investigated as a process to replace the lithography method. An example of this is a process in which a liquid having conductive particles dispersed therein is directly applied on a substrate in a pattern by an ink jet method, followed by heat treatment or laser irradiation, thereby converting the pattern into a conductive film pattern (for example, see U.S. Pat. No. 5,132,248).

However, ink jet patterning methods cannot control the shape, size, position and the like of droplets (liquid) discharged on a substrate, unless an appropriate treatment is applied to the substrate surface, and it is therefore difficult to produce a conductive film pattern having a desired shape. The above prior art reference does not describe a detailed method for controlling the shape of a discharged pattern, and has the problem that pattern accuracy cannot be ensured in practice.

Further, as another example of a method for forming a wiring pattern by a droplet discharging method (hereinafter sometimes referred to as an “ink jet method”), for the purpose of forming, for example, a wiring pattern with good accuracy, a method is proposed in which a lyophilic part and a liquid-repellent part are formed in predetermined patterns on the surface of a substrate using an organic molecular film, and a liquid containing conductive particles is selectively applied in drops on the lyophilic part (see, for example, JP-A-2002-164635).

Wiring pattern formation techniques by an ink jet method are required to narrow the line width of wiring. As a method for achieving this object, a method of forming droplets in small size by applying the above-described liquid in drops to a substrate surface which have been subjected to liquid-repellent treatment is being researched. A method of rendering a substrate surface liquid-repellent includes a method of forming a self-organizing film on a substrate surface using a fluoroalkylsilane. By this method, a fluoroalkyl group is arranged on the surface of the self-organizing film, thereby making the substrate surface liquid-repellent. Specifically, for example, 10 g of hexadecafluoro-1,1,2,2-tetrahydrodecyltriethoxysilane and a glass substrate may be placed in a 10 liter sealed vessel, and held therein at 120° C. for 2 hours.

However, in this method, when a liquid is applied in drops to a liquid-repellent substrate, droplets having a small contact angle to the substrate are formed, and to form a layer comprising conductive particles having a sufficient particle density it is necessary to place many droplets densely. Because of this, many droplets are connected, so that a large amount of a solvent is present on the substrate. As a result, droplet width expands, and the wiring line width is liable to be larger than the set value.

Additionally, because droplets are formed on a liquid-repellent substrate, there is the problem that the adhesion of a wiring layer (a layer comprising conductive particles) is low. Further, there is the problem that the treatment to render the substrate surface liquid-repellent is very inconvenient.

As a method of preventing the enlargement of line width as described above, a reception layer on the surface of the substrate which absorbs a solvent is proposed (for example, see JP-A-5-50741). In a method wherein a porous layer is provided as the receiving layer to absorb the solvent, there is room for improvement as regards the adhesiveness of the wiring layer.

Furthermore, a method of conducting drawing the formation of a circuit pattern of a wiring board with a conductive metal paste using an ink jet method is proposed (for example, see JP-A-2002-324966). However, even with this method it is difficult to form a wiring having a small line width and good adhesion to a substrate.

Therefore, in a method for forming a wiring pattern with a simple ink jet method, it is desirable to form wiring having a small line width and good adhesion to a substrate.

Patent Document 1: U.S. Pat. No. 5,132,248

### Patent Document 2: JP-A-2002-164635

### Patent Document 3: JP-A-5-50741

### Patent Document 4: JP-A-2002-324966

### DISCLOSURE OF THE INVENTION

### Problems to be Solved by the Invention

The present invention has been made to solve the above-described problems, and has an object to provide a pattern forming method that can form a particle layer in a predetermined pattern which has high resolution and good adhesion to a substrate, by a droplet discharging method using a simple apparatus.

Another object of the present invention is to provide a method for forming a multilayer wiring structure having wiring which has high adhesion to a substrate and high resolution, using the above pattern forming method.

### Means for Solving the Problems

As a result of thorough investigation, the present inventors have found that the above problems can be solved by forming a graft polymer on the surface of a substrate and utilizing the properties thereof, and have completed the present invention.

More specifically, one embodiment of the pattern forming method of the present invention comprises: (I) a graft polymer forming step of preparing a substrate whose surface is modified with a graft polymer directly chemically bonded to a base material; (II) a particle-dispersed liquid placing step of placing droplets comprising a dispersion liquid, which comprises a liquid (dispersion medium) and particles dispersed therein, on the graft polymer-formed surface in a predetermined pattern by a droplet discharging method; and (III) a particle pattern forming step of evaporating the liquid (dispersion medium) from the droplets placed, to form a layer comprising the particles on the substrate in a predetermined pattern. This method is hereinafter referred to as a first method of the present invention.

The graft polymer used in the first method of the present invention preferably has at least one component selected from the group consisting of a water-repellent component, a hydrophilic component and a component having metal affinity, depending on the purpose of a pattern formed. Specifically, such a graft polymer is preferably a polymer formed by polymerization of at least one polymerization unit selected from the group consisting of a water-repellent polymerization unit, a hydrophilic polymerization unit and a polymerization unit having metal affinity. Using such a method can form a particle pattern having a predetermined adhesive force to a substrate.

The term “having a predetermined adhesive force” used herein means that, for example, when a peeling test according to JIS C2338 is conducted, force necessary for peeling is 3.5 N or more per 19 mm.

By using a graft polymer having a crosslinking component, in addition to at least one component selected from the group consisting of a water-repellent component, a hydrophilic component and a component having metal affinity, it is possible to further improve adhesion between the graft polymer and the substrate. Such a graft polymer preferably is a copolymer formed by polymerization of at least one or more polymerization units selected from the group consisting of a water-repellent polymerization unit, a hydrophilic polymerization unit and a polymerization unit having metal affinity, and a crosslinkable polymerization unit.

In the present invention, ultraviolet irradiation or heat treatment may be carried out after pattern formation by a droplet discharging method in order to further improve peel strength.

More specifically, another embodiment of the pattern forming method of the present invention comprises: (I) a graft polymer forming step of preparing a substrate whose surface is modified with a graft polymer directly chemically bonded to a base material; (II) a particle-dispersed liquid placing step of placing droplets comprising a dispersion liquid, which comprises a liquid (dispersion medium) and particles dispersed therein, on the graft polymer-formed surface in a predetermined pattern by a droplet discharging method; and (III-2) a particle pattern forming step of subjecting a region including the placed droplets to heating or ultraviolet irradiation, to fix the placed particles on the substrate. This method is referred to as a second method of the present invention.

According to the method of the present invention, a layer comprising particles in a predetermined pattern can be formed with high resolution including a fine line and in a state of good adhesion to a substrate.

Example of the method of the present invention includes a method in which the particles are conductive particles and a wiring pattern is formed by a droplet discharging method. This method corresponds to a method for forming a wiring pattern by a droplet discharging method, and according to this method, a wiring having small line width can be formed in a state of good adhesion to a substrate.

Another embodiment of the present invention, which is a method for forming a multilayer wiring structure using the above-described pattern forming method of the present invention comprises the following steps (A) to (E).

(A) A step of forming a first substrate having a wiring pattern, comprising: a graft polymer forming step of preparing a first substrate whose surface is modified with a graft polymer directly chemically bonded to a first base material; a conductive particle-dispersed liquid placing step of placing droplets comprising a dispersion liquid, which comprises a liquid (dispersion medium) and conductive particles dispersed therein, on the graft polymer-formed surface in a predetermined pattern by a droplet discharging method; and a wiring pattern forming step of evaporating the liquid (dispersion medium) from the droplets placed, to form a layer comprising the conductive particles on the first substrate in a predetermined pattern.

(B) A step of forming a second substrate having a wiring pattern, comprising: a graft polymer forming step of preparing a second substrate whose surface is modified with a graft polymer directly chemically bonded to a base material (second base material), which is different from the first base material; a conductive particle-dispersed liquid placing step of placing droplets comprising a dispersion liquid, which comprises a liquid (dispersion medium) and conductive particles dispersed therein, on the graft polymer-formed surface in a predetermined pattern by a droplet discharging method; and a wiring pattern forming step of evaporating the liquid (dispersion medium) from the droplets placed, to form a layer comprising the conductive particles on the second substrate in a predetermined pattern.

(C) A substrate laminating step of arranging the first substrate having a wiring pattern obtained by the step of forming a first substrate having a wiring pattern and the second substrate having a wiring pattern obtained by the step of forming a second substrate having a wiring pattern such that a wiring pattern-formed face of the first substrate having a wiring pattern faces a non-wiring pattern-formed face of the second substrate having a wiring pattern, and laminating the first substrate having a wiring pattern and the second substrate having a wiring pattern by an adhesive.

(D) A through-hole forming step of providing a through-hole for forming a conductive layer in the second substrate having a wiring pattern obtained by the step of forming a second substrate having a wiring pattern.

(E) A wiring connecting step of placing a conductive material in the through-hole, to connect the wiring pattern on the first substrate having a wiring pattern and the wiring pattern on the second substrate having a wiring pattern.

The substrate laminating step (C) may be conducted between the through-hole forming step (D) and the wiring connecting step (E), in this case the first substrate having a wiring pattern and the second substrate having a wiring pattern may be laminated such that the through-hole coincides with the position of a wiring pattern-formed region on the first substrate having a wiring pattern.

Another embodiment of the method for forming a multilayer wiring structure of the present invention using the pattern forming method of the present invention comprises the following steps (a) to (e).

(a) A step of forming a first substrate having a wiring pattern, comprising: a graft polymer forming step of preparing a first substrate whose surface is modified with a graft polymer directly chemically bonded to a first base material; a conductive particle-dispersed liquid placing step of placing droplets comprising a dispersion liquid, which comprises a liquid (dispersion medium) and conductive particles dispersed therein, on the graft polymer-formed surface in a predetermined pattern by a droplet discharging method; and a wiring pattern forming step of evaporating the liquid (dispersion medium) from the droplets placed, to form a layer comprising the conductive particles on the first substrate in a predetermined pattern.

(b) A laminating step of laminating a second base material on a wiring pattern-formed face of the first substrate having a wiring pattern.

(c) A step of forming a second substrate having a wiring pattern, comprising: a graft polymer forming step of preparing a second substrate whose surface is modified with a graft polymer directly chemically bonded to the second base material; a conductive particle-dispersed liquid placing step of placing droplets comprising a dispersion liquid, which comprises a liquid (dispersion medium) and conductive particles dispersed therein, on the graft polymer-formed surface in a predetermined pattern by a droplet discharging method; and a wiring pattern forming step of evaporating the liquid (dispersion medium) from the droplets placed, to form a layer comprising the conductive particles on the second substrate in a predetermined pattern.

(d) A through-hole forming step of providing a through-hole for forming a conductive layer in the second substrate.

(e) A wiring connecting step of placing a conductive material in the through-hole, to connect the wiring pattern on the first substrate having a wiring pattern and the wiring pattern on the second substrate having a wiring pattern.

In the wiring connecting step (E) or (e) of placing a conductive material in a through-hole, placing the conductive material is preferably conducted by dropping droplets comprising a dispersion medium and conductive particles dispersed therein by a droplet discharging method and evaporating the liquid (dispersion medium) from the droplets. The through-hole is not always required to be entirely filled with the conductive material. According to the purpose, for example, the conductive material may be placed at least along the side wall of the through-hole to form a wiring (conductive material-deposited region) on only a part along the side surface of the hole. This also makes it possible to connect the wiring pattern on the first substrate having a wiring pattern and the wiring pattern on the second substrate having a wiring pattern.

According to a method for forming a multilayer wiring structure of the present invention, it is possible to form a multilayer wiring structure since the formation of a wiring pattern is conducted with the pattern forming method by a droplet discharging method of the present invention.

Using the above substrate having a graft polymer makes it possible to control a shape, a size, a position and the like of droplets on the substrate, which has conventionally been difficult, and makes it easy to prepare a conductive film pattern having a desired shape. Furthermore, a conductive film pattern having good adhesion to a substrate can be obtained. The reason for showing excellent effect by using the substrate of the present invention is not clear. However, for example, where a graft polymer including a water-repellent component, a hydrophilic component, a component having metal affinity and a crosslinking component is used, it is considered that a shape, a size, a position and the like of droplets can further be controlled by a balance between the hydrophobic component and the hydrophilic component, and additionally a conductive film pattern having further good adhesion to a substrate can be obtained by the component having metal affinity and the crosslinking component.

### EFFECT OF THE INVENTION

According to the present invention, a pattern forming method that can form a particle layer in a predetermined pattern that has high resolution and good adhesion to a substrate, by a droplet discharging method using a simple apparatus can be provided.

According to the method for forming a multilayer wiring structure of the present invention, a multilayer wiring structure having high adhesion to a substrate and having a wiring of high resolution can easily be formed by using the pattern forming method.

### BEST MODE FOR CARRYING OUT THE INVENTION

The present invention is described in detail below.

The pattern forming method of the present invention includes a graft polymer forming step of preparing a substrate whose surface is modified with a graft polymer directly chemically bonded to a base material.

### (Surface Graft Polymerization Method)

The graft polymer in the present invention is preferably produced by a surface graft polymerization method.

The surface graft polymerization method is generally a method in which active species are given on a polymer compound chain which forms a solid surface, and another monomer is further polymerized using the active species as a starting point, thereby synthesizing a graft polymer.

In the surface graft polymerization method for realizing the present invention, any conventional methods described in literature references may be used. For example, Shin-Kobunshi Jikkengaku 10, The Society of Polymer Science, Japan, 1994, page 135, Kyoritsu Shuppan Co., Ltd., describes a photografting polymerization method and a plasma irradiation graft polymerization method as a surface graft polymerization method. Furthermore, Kyuchaku Gijyutsu Binran, NTS Inc., supervision by Takeuchi, February 1999, pages 203 and 695 describes a radiation (such as γ ray or electron beam) irradiation graft polymerization method.

The methods described in JP-A-63-92658, JP-A-10-296895 and JP-A-11-119413 can be used as the specific method of the photografting polymerization method.

In a plasma irradiation graft polymerization method and a radiation irradiation polymerization method, a graft polymer can be produced by the methods described in the above-described literatures, and as described in Ikeda et al., Macromolecules, vol. 19, page 1804 (1986) and the like. Specifically, a surface of a polymer such as PET is treated with plasma or electron beam to generate radicals on the surface, and the active surface is then reacted with a monomer, thereby a graft polymer can be obtained.

In the photografting polymerization method, a graft polymer can be obtained by applying a photopolymerizable composition to a surface of a film base material, contacting the surface with a radical polymerizable compound, and irradiating the surface with light, as described in JP-A-53-17407 (Kansai Paint Co., Ltd.) and JP-A-2000-212313 (Dainippon Ink and Chemicals, Incorporated), in addition to the above-described literatures.

As the means for forming a state in which a graft polymer is bonded to a substrate, other than those, a reactive functional group such as a trialkoxysilyl group, an isocyanate group, an amino group, a hydroxyl group or a carboxyl group is imparted to the terminal of a polymer compound chain, followed by a coupling reaction between the reactive functional group and the functional group on the surface of the base material to form the state.

In the graft polymer forming step in the present invention, the specific method in the case of using the surface graft polymerization method is described.

In the present invention, a polymerizable compound shown below is contacted with the base material surface to impart energy to the surface, thereby generating an active point on the base material surface. The active point is reacted with the polymerizable group of the polymerizable compound, and as a result, a surface graft polymerization reaction is induced.

Contacting such a polymerizable compound with the base material surface may be conducted by dipping the base material in a liquid composition containing the polymerizable compound. However, the contact is preferably conducted by applying the liquid composition containing the polymerizable compound to the base material surface from the standpoints of handling properties and production efficiency.

As an energy imparting method, heating, radiation irradiation or the like may be used. More specifically, light irradiation with UV lamp, visible light or the like; heating with a hot plate or the like; and the like may be used.

In the present invention, the graft polymer directly bonded to the base material is a graft polymer preferably including at least one component of a water-repellent component, a hydrophilic component and a component having metal affinity, and more preferably further including a crosslinking component.

The graft polymer in the present invention is preferably a polymer produced by copolymerization of at least one monomer selected from the group consisting of a water-repellent polymerization unit (a water-repellent group-containing monomer), a hydrophilic polymerization unit (a hydrophilic group-containing monomer) and a polymerization unit having metal affinity (a metal-affinic group-containing monomer) according to the purpose, and a crosslinkable polymerization unit (a crosslinking group-containing monomer). A graft polymer which is the copolymer can be directly bonded to the base material by using the surface graft polymerization method described above.

The polymerizable compound may be any of a monomer, a macromer and a polymer having a polymerizable group, but a monomer is particularly preferable from the standpoint of polymerizability.

Monomer that can be used in the formation of the graft polymer in the present invention is described in detail below.

Examples of the water-repellent group-containing monomer include fluorine monomers.

### —Fluorine-Containing Monomer—

Examples of the fluorine-containing monomer used in the graft polymer forming step (A) include at least one fluorine-containing monomer selected from the group consisting of the following general formulae (I), (II), (III), (IV) and (V).

CH₂═CR¹COOR²R^{f} (I)

In formula (I), R¹ represents a hydrogen atom or a methyl group, R² represents —CₚH₂ₚ—, —C(CₚH₂ₚ₊₁)H—, —CH₂C(CₚH₂ₚ₊₁)H— or —CH₂CH₂O—, and R^{f} represents —CₙF₂ₙ₊₁, —(CF₂)ₙH, —CₙF₂₊₁—CF₃, —(CF₂)ₚOCₙH₂ₙCᵢF₂ᵢ₊₁, —(CF₂)ₚOCₘH₂ₘCᵢF₂ᵢH, —N(CₚH₂ₚ₊₁)COCₙF₂₊₁ or —N(CₚH₂ₚ₊₁)SO₂CₙF₂₊₁, wherein p is an integer of from 1 to 10, n is an integer of from 1 to 16, m is an integer of from 0 to 10 and i is an integer of from 0 to 16.

CF₂═CFOR^{g} (II)

In formula (II), R^{g} represents a fluoroalkyl group having from 1 to 20 carbon atoms.

CH₂═CHR^{g} (III)

In Formula (III), R^{g} represents a fluoroalkyl group having from 1 to 20 carbon atoms.

CH₂═CR³COOR⁵R^{j}R⁶OCOCR⁴═CH₂ (IV)

In formula (IV), R³ and R⁴ each independently represent a hydrogen atom or a methyl group, R⁵ and R⁶ each independently represent —C_{q}H_{2q}—, —C(C_{q}H_{2q+1})H—, —CH₂C(C_{q}H_{2q+1})H— or —CH₂CH₂O—, and R^{j} represents —CₜF₂ₜ, wherein q is an integer of from 1 to 10 and t is an integer of from 1 to 16.

CH₂═CHR⁷COOCH₂(CH₂R^{K})CHOCOCR⁸═CH₂ (V)

In formula (V), R⁷ and R⁸ each independently represent a hydrogen atom or a methyl group, and R^{k} represents —C_{y}F_{2y+1}, wherein y is an integer of from 1 to 16.

Specific examples of the fluorine-containing monomer used in the graft polymer forming step (A) are described below, but the present invention is not limited to those.

Examples of the monomer represented by the general formula (I) include CF₃(CF₂)₇CH₂CH₂OCOCH═CH₂, CF₃CH₂OCOCH═CH₂, CF₃(CF₂)₄CH₂CH₂OCOC(CH₃)═CH₂, C₇F₁₅CON(C₂H₅)CH₂OCOC(CH₃)═CH₂, CF₃(CF₂)₇SO₂N(CH₃)CH₂CH₂OCOCH═CH₂, CF₃(CF₂)₇SO₂N(C₃H₇)CH₂CH₂OCOCH═CH₂, C₂F₅ SO₂N(C₃H₇)CH₂CH₂OCOC(CH₃)═CH₂, (CF₃)₂CF(CF₂)₆(CH₂)₃OCOCH═CH₂, (CF₃)₂CF(CF₂)₁₀(CH₂)₃OCOC(CH₃)═CH₂, CF₃(CF₂)₄CH(CH₃)OCOC(CH₃)═CH₂, CF₃CH₂OCH₂CH₂OCOCH═CH₂, C₂F₅(CH₂CH₂O)₂CH₂OCOCH═CH₂, (CF₃)₂CFO(CH₂)₅OCOCH═CH₂, CF₃(CF₂)₄OCH₂CH₂OCOC(CH₃)═CH₂, C₂F₅CON(C₂H₅)CH₂OCOCH═CH₂, CF₃(CF₂)₂CON(CH₃)CH(CH₃)CH₂OCOCH═CH₂, H(CF₂)₆C(C₂H₅)OCOC(CH₃)═CH₂, H(CF₂)₈CH₂OCOCH═CH₂, H(CF₂)₄CH₂OCOCH═CH₂, H(CF₂)CH₂OCOC(CH₃)═CH₂, CF₃(CF₂)₇SO₂N(CH₃)CH₂CH₂OCOC(CH₃)═CH₂, CF₃(CF₂)₇SO₂N(CH₃)(CH₂)₁₀OCOCH═CH₂, C₂F₅SO₂N(C₂H₅)CH₂CH₂OCOC(CH₃)═CH₂, CF₃(CF₂)₇SO₂N(CH₃)(CH₂)₄OCOCH═CH₂, C₂F₅SO₂N(C₂H₅)C(C₂H₅)HCH₂OCOCH═CH₂, and monomers of the following structures.

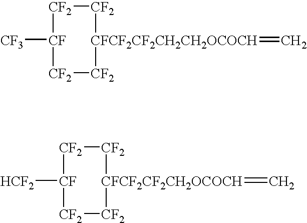

Examples of the fluoroalkylated olefin represented by the general formula (II) or (III) include C₃F₇CH═CH₂, C₄F₉CH═CH₂, C₁₀F₂₁CH═CH₂, C₃F₇OCF═CF₂, C₇F₁₅OCF═CF₂, and C₈F₁₇OCF═CF₂.

Examples of the monomer represented by the general formula (IV) or (V) include CH₂═CHCOOCH₂(CF₂)₃CH₂OCOCH═CH₂ and CH₂═CHCOOCH₂CH(CH₂C₈F₁₇)OCOCH═CH₂.

The hydrophilic group of the hydrophilic group-containing monomer is preferably a polar group, and more preferably an ionic group. Therefore, a monomer having an ionic group (an ionic monomer) is preferably used as the hydrophilic group-containing monomer in the present invention.

Examples of the ionic monomer include monomers having positive charge, such as ammonium or phosphonium, and monomers having an acidic group which has a negative charge or is capable of dissociating into a negative charge, such as a sulfonic group, a carboxyl group, a phosphoric group, or a phosphonic group.

Examples of the ionic monomer capable of forming an ionic group that is preferably used in the present invention include monomers having positive charge, such as ammonium or phosphonium, and monomers having an acidic group which has a negative charge or is capable of dissociating into a negative charge, such as a sulfonic group, a carboxyl group, a phosphoric group, or a phosphonic group, as described above.

Specific examples of the ionic monomer particularly useful in the present invention include the following monomers. For example, (meth)acrylic acid or its alkali metal salt and amine salt; itaconic acid or its alkali metal salt and amine salt; allyl amine or its hydrohalic acid salt; 3-vinylpropionic acid or its alkali metal salt and amine salt; vinylsulfonic acid or its alkali metal salt and amine salt; styrenesulfonic acid or its alkali metal salt and amine salt; 2-sulfoethylene (meth)acrylate; 3-sulfopropylene (meth)acrylate or its alkali metal salt and amine salt; 2-acrylamide-2-methylpropanesulfonic acid or its alkali metal salt and amine salt; acid phosphooxypolyoxyethylene glycol mono(meth)acrylate or a salt thereof; 2-dimethylaminoethyl (meth)acrylate or its hydrohalic acid salt; 3-trimethylammoniumpropyl (meth)acrylate; 3-trimethylammoniumpropyl (meth)acrylamide; N,N,N-trimethyl-N-(2-hydroxy-3-methacryloyloxypropyl)-ammonium chloride; and the like can be used.

Further, monomers having a nonionic polar group shown below as a hydrophilic group can be used.

That is, 2-hydroxyethyl (meth)acrylate, (meth)acrylamide, N-monomethylol (meth)acrylamide, N-dimethylol (meth)acrylamide, N-vinylacetamide, polyoxyethylene glycol mono(meth)acrylate and the like are useful.

Examples of the monomer having a metal-affinic group include monomers containing a nitrogen atom or a sulfur atom, and particularly monomers having a hetero ring containing an atom such as a nitrogen atom or a sulfur atom. Examples of the monomer containing a nitrogen atom include dimethyl aminomethacrylate and trimethylammonium ethyl acrylate, and examples of the monomer having a hetero ring containing a nitrogen atom include 2-vinylpyridine, 4-vinylpyridine, 1-vinylimidazole and N-vinylpyrrolidone.

Those monomers may be appropriately selected and used considering interaction to particles to be adhered and fixed, and may be used alone or as mixtures of two or more thereof.

In the present invention, it is preferred to use a crosslinkable polymerization unit (a crosslinkable group-containing monomer) together for the purpose of further improving adhesion between a graft polymer or a particle pattern formed thereon and a base material. The monomer having a crosslinkable group (that is, a reactive monomer) that can be used in the present invention may appropriately be selected from the conventional monomers and used.

Specific examples of the monomer having a crosslinkable group include monomers having a hydroxyl group, such as 2-hydroxyethyl acrylate, 3-hydroxybutyl acrylate, 2-hydroxypropyl acrylate, 3-hydroxypropyl acrylate, 2-hydroxyethyl methacrylate, 3-hydroxybutyl methacrylate, 2-hydroxybutyl methacrylate or 4-hydroxybutyl methacrylate; monomers having a methylol group, such as N-methylol acrylamide, N-methylol methacrylamide or methylol stearoamide; monomers having a glycidyl group, such as glycidyl acrylate or glycidyl methacrylate; monomers having an isocyanate group, such as 2-isocyanatoethyl methacrylate (for example, Karenz MOI, trade name, a product of Showa Denko K.K.); and monomers having an amino group, such as 2-aminoethyl acrylate or 2-aminoethyl methacrylate.

### (Base Material)

The base material used in the present invention is a dimensionally stable plate-like material, and any material may be used as long as it satisfies necessary flexibility, strength, durability and the like. The base material is appropriately selected according to the purpose of use.

When a transparent base material which requires light transmission properties is used, examples of such a base material include glasses and plastic films (such as cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate or polyvinyl acetal).

As a base material which does not require transparency, polymers having high thermal durability, high electric insulating properties and low dielectric constant, such as an epoxy resin, a polyimide resin, a liquid crystal polymer or a fluorine resin may be used, in addition to the above-described materials.

Next, the particle-dispersed liquid placing step of placing droplets comprising a dispersion liquid comprising a liquid (dispersion medium) and particles dispersed therein on the graft polymer-formed surface formed by the step (I) (graft polymer forming step) in a predetermined pattern by a droplet discharging method is conducted.

### (Droplet Discharging Step)

Droplets discharged by, for example, an ink jet recording apparatus are a particle-dispersed liquid comprising particles (particles) used for the formation of a particle pattern, dispersed in an appropriate dispersion medium. The particles used for the formation of a particle pattern are not particularly limited, and are selected according to the purpose. The particle size is preferably 0.1 μm or less, and more preferably in a range of from 5 nm to 0.1 μm, from the standpoint of discharging properties.

For example, when colored particles are used as particles applied to a substrate, an image can be formed on the substrate, and when ultraviolet absorbing particles are used, a substrate having a local ultraviolet absorption power can be obtained. Representative methods thereof include a method of forming a conductive wiring pattern by using conductive particles. The embodiment using conductive particles as the particles is described below.

When a wiring is formed, a liquid material discharged in the discharging step is a liquid material containing conductive particles (pattern forming component) in a dispersed state (conductive particle-dispersed liquid). The conductive particles used in this case are metal particles containing any one of gold, silver, copper, palladium and nickel, and particles of a conductive polymer or a superconductor.

The conductive particles can be used by coating the surface thereof with an organic material or the like in order to improve dispersibility. Examples of the coating material which is applied to the surface of the conductive particles include an organic solvent such as xylene or toluene, and citric acid.

The particle size of the conductive particles is preferably from 5 nm to 0.1 μm. Where the particle size is larger than 0.1 μm, clogging of nozzles is liable to occur, making it difficult to discharge such conductive particles by an ink jet method. On the other hand, where the particle size is less than 5 nm, volume ratio of the coating material to the conductive particles increases, and as a result, the proportion of an organic material in a film obtained is excessive.

The dispersion medium of a liquid containing conductive particles is preferably a dispersion medium having vapor pressure at room temperature of from 0.001 to 200 mmHg (about 0.133 to 26,600 Pa). Where the vapor pressure is higher than 200 mmHg, the dispersion medium rapidly evaporates after discharging, making it difficult to form a good film.

The vapor pressure of the dispersion medium is more preferably from 0.001 to 50 mmHg (about 0.133 to 6,650 Pa). Where the vapor pressure is higher than 50 mmHg, clogging of nozzles due to drying is liable to occur in discharging droplets by an ink jet method, making it difficult to conduct stable discharging. On the other hand, where the dispersion medium has vapor pressure at room temperature lower than 0.001 mmHg, drying becomes slow, and the dispersion medium is liable to remain in a film. As a result, a conductive film having good quality is difficult to be obtained after heat and/or light treatment as a post-treatment.

The dispersion medium used is not particularly limited as long as it can disperse the conductive fine particles and does not cause agglomeration. Examples of the dispersion medium include water; alcohols such as methanol, ethanol, propanol or butanol; hydrocarbon compounds such as n-heptane, n-octane, decane, toluene, xylene, cymene, durene, indene, dipentene, tetrahydronaphthalene, decahydronaphthalene or cyclohexylbenzene; ether compounds such as ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, 1,2-dimethoxyethane, bis(2-methoxyethyl)ether or p-dioxane; and polar compounds such as propylene carbonate, γ-butyrolactone, N-methyl-2-pyrrolidone, dimethylformamide, dimethylsulfoxide or cyclohexanone. Of those, from the points of dispersibility of particles, and stability and easy application to an ink jet method of a dispersion liquid, water, alcohols, hydrocarbon compounds and ether compounds are preferable, and water and hydrocarbon compounds are more preferable as a dispersion medium. Those dispersion media can be used alone or mixtures of two or more thereof.

Dispersoid concentration when the conductive particles are dispersed in the dispersion medium is from 1 to 80 mass %, and can be controlled according to the desired film thickness of a conductive film. Where the concentration exceeds 80 mass %, agglomeration is liable to occur, making it difficult to obtain a uniform film.

Surface tension of the dispersion liquid of the conductive particles is preferably in a range of from 0.02 to 0.07 N/m. In discharging a liquid by an ink jet method, where the surface tension is less than 0.02 N/m, wettability of an ink composition to nozzle surface increases, and as a result, fly bending is liable to occur. Where the surface tension exceeds 0.07 N/m, meniscus shape at a nozzle tip is not stabilized, and as a result, it is difficult to control discharge amount and discharge timing.

To adjust the surface tension, a slight amount of fluorine type, silicon type or nonionic surface tension regulator can be added in a range that contact angle to a substrate is not unduly decreased. The nonionic surface tension regulator improves wettability of a liquid to a substrate, improves leveling properties of a film, and is therefore useful to prevent generation of bumps and generation of orange peel surface on a coating film. If necessary, the dispersion liquid may contain an organic compound such as alcohols, ethers, esters or ketones.

Viscosity of the dispersion liquid is preferably from 1 to 50 mPa·s.

In discharging the dispersion liquid by an ink jet method, where the viscosity is smaller than 1 mPa·s, peripheral part of a nozzle is liable to be soiled with outflow of an ink. On the other hand, where the viscosity is larger than 50 mPa·s, frequency of clogging in a nozzle hole increases, making it difficult to smoothly discharge droplets.

In this embodiment, droplets of the dispersion liquid are discharged from an ink jet head, and are put on a location of a substrate on which wiring is formed. In this case, it is necessary to control the degree of overlapping of droplets subsequently discharged in order that liquid puddle (bulge) is not generated. Furthermore, the discharging method can be employed such that in the first discharging, plural droplets are discharged with interval so as not to contact with each other, and the interval is filled by the discharging of the second or later discharge.

After discharging the droplets, drying treatment is conducted according to need in order to remove the dispersion medium. The drying treatment may be conducted by usual treatment for heating a substrate, for example, treatment with a hot plate, treatment with an electric furnace, or the like. As the drying treatment, lamp annealing may be conducted. A light source of light used in lamp annealing is not particularly limited. As the light source, an infrared lamp, a xenon lamp, YAG laser, argon laser, CO₂ laser, excimer laser of, for example, XeF, XeCl, XeBr, KrF, KrCl, ArF or ArCl, or the like may be used. Those light sources generally have output in a range of from 10 to 5,000 W In the present embodiment, the output may be in a range of from 100 to 1,000.

### (Heat Treatment/Light Treatment Step)

In a dry film after the discharging step, it is preferred to completely remove the dispersion medium in order to facilitate electrical contact among particles. Furthermore, when the surface of the conductive particles is coated with a coating material such as an organic material to improve dispersibility, it is preferred to remove the coating material. Therefore, it is preferred to apply heat treatment and/or light treatment to the substrate after the discharging step.

The heat treatment and/or light treatment are generally conducted in the atmosphere, but can be conducted in an inert gas atmosphere such as nitrogen, argon or helium according to need. Treatment temperature of the heat treatment and/or light treatment is appropriately determined considering a boiling point (vapor pressure) of a dispersion medium, a kind or pressure of an atmosphere gas, thermal behaviors of dispersibility, oxidizing properties and the like of particles, an amount and existence or nonexistence of a coating material, heat-resistant temperature of a base material, and the like. For example, to remove a coating material comprising an organic material, it is necessary to bake at about 300° C. When a substrate such as a plastic is used, it is preferred to conduct the baking at a temperature of from room temperature to 100° C.

The heat treatment and/or light treatment may be conducted by the usual treatment with a hot plate, an electric furnace or the like. The heat treatment and/or light treatment may be conducted by lamp annealing. Light source of light used in the lamp annealing is not particularly limited. An infrared lamp, a xenon lamp, YAG laser, argon laser, CO₂ laser, excimer laser of XeF, XeCl, XeBr, KrF, KrCl, ArF, ArCl, or the like, and the like may be used as the light source. Those light sources generally have output in a range of from 10 to 5,000 W. In the present embodiment, the output may be in a range of from 100 to 1,000 W By conducting this treatment, electrical contact among conductive particles is ensured in a dry film after the discharge treatment, and the dry film is converted into a continuous conductive film (conductive region). When a graft polymer containing a crosslinkable polymerization unit is used, by conducting this treatment, there are the advantages that a crosslinked structure is formed in the polymer, and adhesion of the conductive particles is further improved.

Thus, the conductive particle pattern (wiring pattern) formed by the present embodiment can form good and desired conductive film wiring without occurrence of defects such as breaking of wire.

When a wiring pattern is formed using the pattern forming method of the present invention, a wiring or an electrode, having excellent adhesion to a substrate and having high fineness according to accuracy of the discharging apparatus can easily be obtained on the substrate. The embodiment of forming a wiring pattern on a single layer substrate is described here. However, when this method is applied, a multilayer wiring structure can easily be formed, and the above-described droplet discharging method can be applied to form not only a wiring on the substrate or the surface of an insulating layer, but conductive passage among wirings formed on a multilayer.

A method for forming the multilayer wiring structure is described below.

This method includes (A) a first substrate (a first substrate having a wiring pattern) forming step of forming a wiring pattern nearest a support, (B) a second substrate (a second substrate having a wiring pattern) forming step of forming a wiring at a second layer laminated on the first substrate, (C) a substrate laminating step of laminating and adhering the first substrate and the second substrate obtained above, (D) a through-hole forming step of providing a through-hole for forming a conductive region which connects conductive layers, that is, mutual wirings, on the second substrate obtained by the second substrate forming step, and (E) a wiring connecting step of placing a conductive material in the through-hole, to connect the wiring pattern on the first substrate and the wiring pattern on the second substrate.

Similar to the pattern forming method of the present invention described before, the first substrate forming step (A) includes: (I) a graft polymer forming step of preparing a substrate whose surface is modified with a graft polymer directly chemically bonded to a base material; (II) a conductive particle-dispersed liquid placing step of placing droplets comprising a dispersion liquid, which comprises a liquid (dispersion medium) and conductive particles dispersed therein, on the graft polymer-formed surface in a predetermined pattern by a droplet discharging method; and (III) a wiring pattern forming step of evaporating the liquid (dispersion medium) from the droplets placed to form a layer comprising the conductive particles on the substrate in a predetermined pattern. The same is applied to the second substrate forming step (B).

(C) In the substrate laminating step, the first substrate obtained by the step of forming a first substrate having a wiring pattern and the second substrate obtained by the step of forming a second substrate having a wiring pattern are arranged such that a wiring pattern-formed face of the first substrate faces a non-wiring pattern-formed face of the second substrate, and the first substrate and the second substrate are laminated with an adhesive.

A through-hole for forming the conductive layer (D) is provided on a predetermined position of the second substrate obtained in the step (B). Formation of the through-hole can be conducted by the conventional methods.

Examples of the processing method of forming the through-hole include the conventional methods using a drill machine, a dry plasma apparatus, CO₂ laser, UV laser, excimer laser or the like. Above all, a method of using UV-YAG laser or excimer laser is more preferred for the reason that formation of a small-sized and good shaped via hole is possible. Where the via hole is formed with decomposition by laser heating as in a method of using CO₂ laser or the like, it is more preferred to further conduct desmear treatment. When the desmear treatment is conducted, formation of the conductive layer in the via hole inside in the post-step can be conducted better.

The step (C) may be conducted after the step (D). In other words, the first substrate obtained by the step (C) of forming a first substrate having a wiring pattern and the second substrate obtained by the step of forming a second substrate having a wiring pattern are arranged such that a wiring pattern-formed face of the first substrate faces a non-wiring pattern-formed face of the second substrate and the through-hole provided in the second substrate coincides with the position of a wiring pattern-formed region on the first substrate, and the first substrate and the second substrate are laminated with an adhesive.

Kind of the adhesive used for adhesion is not particularly limited. Roughly classifying in the kind of adhesive resins contained, two kinds of (A) hot-melt adhesives using thermoplastic resins, and (B) curable resins using a curing reaction of thermosetting resins (heat-curable resins) are the representative adhesives.

Examples of the thermoplastic resin (A) that can be used as an adhesive which imparts hot-melt properties include polyimide resins, polyamideimide resins, polyetherimide resins, polyamide resins, polyester resins, polycarbonate resins, polyketone resins, polysulfone resins, polyphenylene ether resins, polyolefin resins, polyphenylene sulfide resins, fluorine resins, polyacrylate resins and liquid crystal polymer resins. At least one, or appropriate combination of two or more of those can used as an adhesive. Above all, thermoplastic polyimide resins are more preferably used from the standpoints of excellent heat resistance, electrical reliability, adhesion, processability, flexibility, dimensional stability, dielectric constant, cost performance and the like.

The kind of the thermosetting resin (B) that can be used as an adhesive giving heat curing properties is not particularly limited, and specific examples thereof include bismaleimide resins, bisallylnadimide resins, phenolic resins, cyanate resins, epoxy resins, acrylic resins, methacrylic resins, triazine resins, hydroxyl curable resin, allyl curable resins and unsaturated polyester resins. Those can be used alone or in appropriate combination. Above all, epoxy resins and cyanate resins are particularly preferred from the standpoints of having excellent adhesion, processability, heat resistance, flexibility, dimensional stability, dielectric constant, cost performance and the like. Other than the above-described thermosetting resins, side chain reactive group type thermosetting polymers having a reactive group such as an epoxy group, an allyl group, a vinyl group, an alkoxysilyl group, a hydrosilyl group or a hydroxyl group at a side chain or a terminal of a polymer chain can be used as a thermosetting component.

The thermoplastic resin and the thermosetting resin can be mixed for the purpose of controlling flowability when heat adhering. The mixing proportion of those is not particularly limited. The thermosetting resin is added in an amount of preferably from 1 to 10,000 parts by weight, and more preferably from 5 to 2,000 parts by weight, per 100 parts by weight of thermoplastic resin. The above mixing proportion is more preferable because when the proportion of the thermosetting resin occupied in the mixed resin is too large, the adhesive layer is likely to be brittle, and when the proportion is too small, flowability and adhesion of the adhesive is likely to deteriorate.

A mixed resin of an epoxy resin or a cyanate resin, and the thermoplastic polyimide resin is particularly preferable as the mixed resin of the thermoplastic resin and the thermosetting resin from the standpoints of having excellent adhesion, processability, heat resistance, flexibility, dimensional stability, dielectric constant, cost performance and the like.

A conductive passage which electrically connects the wiring pattern formed on the second substrate and the wiring pattern formed on the first wiring pattern is formed by conducting the wiring connecting step (E) of placing a conductive material in the through-hole to connect the wiring pattern on the first substrate and the wiring pattern on the second substrate.

Examples of the conductive material placed in the through-hole include metals such as copper, nickel, chromium, titanium, aluminum, molybdenum, tungsten, zinc, tin, indium, gold and silver; metal materials such as alloys of those metals (such as Nichrome); conductive polymer materials such as polypyrrole and polythiophene; and non-metallic inorganic conductive materials such as graphite and conductive ceramics.

As the method for placing a conductive material, an electroless plating method or a coating method can be applied, in addition to the above-described droplet discharging method. In view of simplicity of the apparatus, it is preferred to give conductive particles similar to those in the formation of a wiring pattern on a substrate, by the droplet discharging method. Use of those methods makes it possible to form a conductive region in fine space such as an inner surface of a through-hole relatively uniformly and easily. The conductive material is not always filled over the entire region of the through-hole, and may be formed on only a portion along the wall surface of the through-hole as long as necessary conductivity as a conductive passage can be ensured.

Such step may be repeated several times, thereby the desired multilayer wiring structure can be formed easily.

Another embodiment of the method for forming a multilayer wiring structure includes the following steps (a) to (e).

(a) A step of forming a first substrate having a wiring pattern, comprising: a graft polymer forming step of preparing a first substrate whose surface is modified with a graft polymer directly chemically bonded to a first base material; a conductive particle-dispersed liquid placing step of placing droplets comprising a dispersion liquid, which comprises a liquid (dispersion medium) and conductive particles dispersed therein, on the graft polymer-formed surface in a predetermined pattern by a droplet discharging method; and a wiring pattern forming step of evaporating the liquid (dispersion medium) from the droplets placed, to form a layer comprising the conductive particles on the first substrate in a predetermined pattern.

(b) A laminating step of laminating a second base material on a wiring pattern-formed face of the first substrate having a wiring pattern.

(c) A step of forming a second substrate having a wiring pattern, comprising: a graft polymer forming step of preparing a second substrate whose surface is modified with a graft polymer directly chemically bonded to the second base material; a conductive particle-dispersed liquid placing step of placing droplets comprising a dispersion liquid, which comprises a liquid (dispersion medium) and conductive particles dispersed therein, on the graft polymer-formed surface in a predetermined pattern by a droplet discharging method; and a wiring pattern forming step of evaporating the liquid (dispersion medium) from the droplets placed, to form a layer comprising the conductive particles on the second substrate in a predetermined pattern.

(d) A through-hole forming step of providing a through-hole for forming a conductive layer in the second substrate.

(e) A wiring connecting step of placing a conductive material in the through-hole, to connect the wiring pattern on the first substrate having a wiring pattern and the wiring pattern on the second substrate having a wiring pattern.

In this case, the first substrate having a wiring pattern may be a glass substrate having a wiring pattern, or may be a wiring substrate prepared by applying a subtractive method to a glass epoxy copper-clad substrate generally used.

The through-hole forming step (d) may be conducted between the graft polymer forming step and the wiring pattern forming step in the step of forming a second substrate having a wiring pattern (c). In this case, for example, a hole may be formed in the second substrate with laser in a state that the second substrate which does not have a wiring pattern is laminated on the first substrate having a wiring pattern, and then the graft pattern part and the hole part of the second substrate may be subjected to conductive treatment at one time.

The step of forming a first substrate having a wiring pattern (a) and the step of forming a second substrate having a wiring pattern (b) are similar to the above step (A) and step (B) respectively. Furthermore, the through-hole forming step (d) and the wiring connecting step (e) are similar to the above step (D) and step (E), respectively.

The disclosure of Japanese Patent Application No. 2005-148404 is incorporated herein by reference in its entity.

All publications, patent applications and technical standards described herein are incorporated herein by reference to the same extent that as if each individual publication, patent application and technical standard was specifically and individually indicated to be incorporated by reference.

### EXAMPLES

The present invention is described in detail by referring to the Examples, but the invention is not construed as being limited thereto.

### Synthesis Example 1

### Synthesis of Compound A

Synthesis of compound A is conducted by the following two steps.

### 1. Step 1 (Synthesis of Compound a)

24.5 g (0.12 mol) of 1-hydroxycyclohexylphenyl ketone was dissolved in a mixed solvent of 50 g of DMAc and 50 g of THF, and 7.2 g (0.18 mol) of NaH (60% in oil) was gradually added thereto under ice bath. 44.2 g (0.18 mol) of 11-bromo-1-undecene (95%) was added dropwise to the resulting mixture, and reaction was conducted at room temperature. The reaction was completed in 1 hour. The reaction solution was poured into ice water, and extracted with ethyl acetate, thereby a mixture containing compound a in a form of yellow solution was obtained. 37 g of the mixture was dissolved in 370 ml of acetonitrile, and 7.4 g of water was added thereto. 1.85 g of p-toluenesulfonic acid-hydrate was added to the resulting solution, followed by stirring at room temperature for 20 minutes. An organic phase was extracted with ethyl acetate, and a solvent was distilled away. Compound a was isolated with column chromatography (filler: WAKOGEL C-200, developing solvent: ethyl acetate/hexane=1/80).

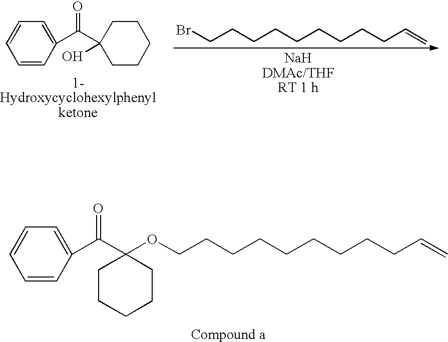

¹H NMR (300 MHz CDCl₃) δ=1.2-1.8 (mb, 24H), 2.0 (q, 2H), 3.2 (t, J=6.6, 2H), 4.9-5.0 (m, 2H), 5.8 (ddt, J=24.4, J=10.5, J=6.6, 1H), 7.4 (t, J=7.4, 2H), 7.5 (t, J=7.4, 1H), 8.3 (d, 1H)

### 2. Step 2 (Synthesis of Compound a by Hydrosilylation of Compound a)

Two droplets of Speir catalyst (H₂PtCl₆.6H₂O/2-PrOH, 0.1 mol/l) were added to 5.0 g (0.014 mol) of compound a, and 2.8 g (0.021 mol) of trichlorosilane was added dropwise under ice bath, followed by stirring. After 1 hour, 1.6 g (0.012 mol) of trichlorosilane was added dropwise, and the temperature was returned to room temperature. The reaction was completed after 3 hours. After completion of the reaction, unreacted trichlorosilane was distilled away under reduced pressure to obtain compound A.

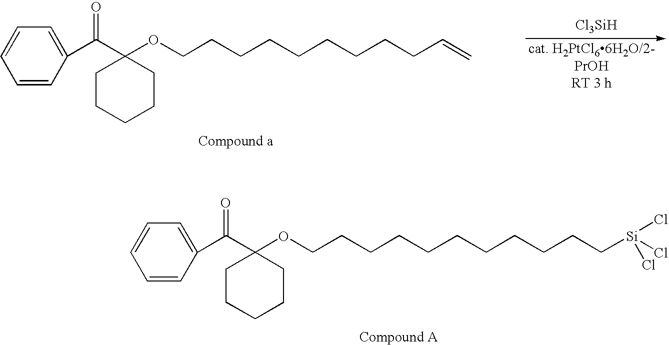

¹H NMR (300 MHz CDCl₃) δ=1.2-1.8 (m, 30H), 3.2 (t, J=6.3, 2H), 7.3-7.7 (m, 3H), 8.3 (d, 2H)

### (Photoinitiator Bonding Step)

A glass substrate (a product of Nippon Sheet Glass Co., Ltd.) was dipped in piranha solution (sulfuric acid/30% hydrogen peroxide=1/1 vol mixed solution) overnight, and then washed with pure water. The substrate was placed in a separable flask purged with nitrogen, and dipped in a dehydrated toluene solution containing 1.0 wt % of compound A for 1 hour. The substrate was taken out of the flask, and then successively washed with toluene, acetone and pure water. The substrate thus obtained is called substrate A1.

### Examples 1 to 4

Monomers 1 to 4 having the following compositions were dissolved in a mixed solvent of 1-methoxy-2-propanol/methyl ethyl ketone (1/1 weight ratio) to prepare a 10 wt % solution. The glass substrate A1 having a photoinitiator bonded thereto obtained above was dipped in this solution, and exposed with an exposure apparatus (UVX-02516S1LP01, a product of Ushio Inc.) for 1 minute. After the exposure, the substrate was sufficiently washed with acetone and pure water. Thus, graft-treated substrates 1 to 4 were obtained.

### [Monomer Composition (Molar Ratio) Constituting Graft Polymer]

Monomer composition 1: Perfluorooctylethyl methacrylate (FMAC) (50%)/dimethyl acrylamide (50%)
Monomer composition 2: FMAC (50%)/hydroxyethyl methacrylate (25%)/1-vinylimidazole (25%)
Monomer composition 3: FMAC (50%)/acrylamide (25%)/2-vinylpyridine (25%)
Monomer composition 4: FMAC (50%)/acrylamide (40%)/glycidyl methacrylate (10%)

PERRECT SILVER, a product of Vacuum Matellurgical Co., Ltd., was prepared as a particle-dispersed liquid. This liquid is a dispersion liquid comprising toluene and silver particles having a particle diameter of 0.01 μm dispersed therein, and has a viscosity of about 10 mPa·s.

The substrates 1 to 4 were placed on X-Y stage, facing a graft surface upwardly. The liquid obtained above was dropped dropwise from an ink jet nozzle to the graft surface while moving the substrate 1 by the X-Y stage, thereby droplets comprising the liquid were placed on the graft surface in a predetermined pattern.

An ink jet apparatus, MJ-10000, a product of Seiko Epson Corporation, was used as the ink jet apparatus. An ink jet head equipped with 180 nozzles per line was used as the ink jet head, and droplets were continuously formed along the lengthwise direction of a wiring using only one line. That is to say, one droplet was formed in the width direction of a wiring. The conditions for dropping a liquid from a nozzle were set to obtain a distance between substrate surface and nozzle of 0.3 mm and one discharging amount of 10 ng such that droplet dropped has a diameter of from 25 to 30 μm. Furthermore, it was adjusted that droplets are dropped in the lengthwise direction of a wiring with a distance (distance between centers of droplets) of 20 μm.

The substrate 1 in this state was placed in a hot air drying oven, and held therein at 250° C. for 1 hour, thereby drying droplets and removing the dispersion medium. Thus, a particle pattern (wiring pattern) comprising silver particles contained in the droplets was formed on a graft polymer.

### <Evaluation of Wiring Pattern>

### 1. Shape of Wiring Pattern.

Width of the wiring pattern formed was measured.

### 2. Evaluation of Conductivity (Resistivity)

In the wiring pattern formed, volume resistivity of a part having a wiring formed thereon was measured using LORESTOR-FP, a product of Mitsubishi Chemical Corporation.

### 3. Evaluation of Conductive Film Adhesion

A conductive particle pattern layer (wiring pattern region) was formed on a region of 10×200 (mm) in a similar manner as the wiring pattern forming method, and film adhesion was evaluated by a cross-cut adhesion tape method according to JIS 5400. Peeling test of a tape to cross-cuts was conducted.

Those results are shown in Table 1 below.

TABLE 1

| | | Width of | Volume | |
|---|---|---|---|---|
| | | wiring | resistivity | |
| | | pattern | of wiring | |
| | Substrate | (μm) | (μΩ · cm) | Adhesion |
| Example 1 | 1 | 25 | 3 | No peeling |
| Example 2 | 2 | 20 | 2 | No peeling |
| Example 3 | 3 | 23 | 4 | No peeling |
| Example 4 | 4 | 28 | 4 | No peeling |

### Example 5

A liquid insulating resin layer forming material having the following composition was applied to the wiring pattern substrate prepared in Example 1 by curtain coater, dried at 110° C. for 20 minutes, and then cured at a temperature of 150° C. for 30 minutes to form an epoxy resin-made insulating resin layer having a thickness of 60 μm.

### (Composition of Insulating Resin Layer Forming Material)

Epoxidized resin (EPIKOAT 1001, a product of Yuka Shell Epoxy Co., Ltd.): 100 parts

Epoxidized resin (EPIKOAT 828, a product of Yuka Shell Epoxy Co., Ltd.): 50 parts

Rubber-modified epoxy resin (YR-450, a product of Tohto Kasei Co., Ltd.): 50 parts

Imidazole epoxy hardener (Curesol 2MZ-A, a product of Shikoku Kasei Kogyo Co., Ltd.): 5 parts

Phenolic resin (HF-1, a product of Meiwa Plastic Industries, Ltd.): 20 parts

Light calcium carbonate (average particle size 3 μm or less): 35 parts

Fine silica powder (average particle size 1.5 μm or less): 15 parts

The insulating resin layer thus formed was dipped in a solution of perfluorooctylethyl methacrylate (FMAC) (7 parts by weight), hydroxyethyl methacrylate (HEMA) (3 parts by weight) and 1-methoxy-2-propanol (90 parts by weight), and exposed using an exposure apparatus (UVX-02516S1LP01, a product of Ushio Inc.) for 1 minute. After the exposure, the surface of the substrate was sufficiently washed with acetone and pure water.

Then, an opening for via hole formation was provided using carbon dioxide gas laser. Processing conditions in this case are pulse width 15/12/5 μsec, and shot number 1/1/1 (laser processing machine LCO-1B21, a product of Hitachi Via Mechanics, Ltd.).

A wiring pattern was formed with ink jet in the same manner as in Example 1. In this case, a pattern was drawn on the opening for via hole formation prepared by laser to form a conductive passage of a lower layer and an upper layer. Thus, a multilayer wiring board of Example 5 was obtained.

### Example 6

A first circuit layer (first conductive pattern) was formed on a glass epoxy copper-clad laminate board by a subtractive method. A liquid insulating resin layer forming material having the following composition was applied to the first circuit layer by curtain coater, dried at 110° C. for 20 minutes, and then cured at a temperature of 150° C. for 30 minutes to form an epoxy resin-made insulating resin layer having a thickness of 60 μm.

### (Composition of Insulating Resin Layer Forming Material)

Epoxidized resin (EPIKOAT 1001, a product of Yuka Shell Epoxy Co., Ltd.): 100 parts

Epoxidized resin (EPIKOAT 828, a product of Yuka Shell Epoxy Co., Ltd.): 50 parts

Rubber-modified epoxy resin (YR-450, a product of Tohto Kasei Co., Ltd.): 50 parts

Imidazole epoxy hardener (CURESOL 2MZ-A, a product of Shikoku Kasei Kogyo Co., Ltd.): 5 parts

Phenolic resin (HF-1, a product of Meiwa Plastic Industries, Ltd.): 20 parts

Light calcium carbonate (average particle size 3 μm or less): 35 parts

Fine silica powder (average particle size 1.5 μm or less): 15 parts

A polymerization initiation layer coating liquid having the following composition was applied to the insulating resin layer thus formed. After the application, the polymerization initiation layer was dried at 100° C. for 10 minutes. Film thickness after drying was 1 μm.

### (Polymerization Initiation Layer Coating Liquid 1)

Specific polymerization initiation polymer A: 0.4 g

TDI (tolylene-2,4-diisocyanate): 0.16 g

Methyl ethyl ketone (MEK): 1.6 g

The polymerization initiation polymer A was synthesized as follows.

### (Synthesis of Polymerization Initiation Polymer A)

30 g of propylene glycol monomethyl ether (MFG) was added to a 300 ml three-necked flask, followed by heating to 75° C. A solution of 8.1 g of [2-(acryloyloxy)ethyl](4-benzoylbenzyl)dimethyl ammonium bromide, 9.9 g of 2-hydroxyethyl methacrylate, 13.5 g of isopropyl methacrylate, 0.43 g of dimethyl-2,2′-azo bis(2-methylpropionate) and 30 g of MFG was added dropwise to the flask over 2.5 hours. Thereafter, reaction temperature was elevated to 80° C., and reaction was further conducted for 2 hours, thereby obtaining the following specific polymerization initiation polymer A.

### Specific Polymerization Initiation Polymer A

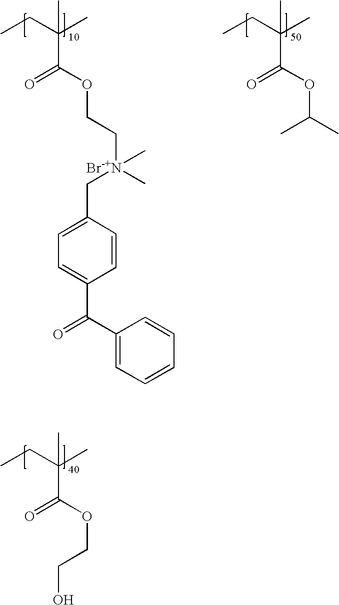

The polymerization initiation layer/insulating resin layer thus formed were dipped in a solution of perfluorooctylethyl methacrylate (FMAC) (7 parts by weight), hydroxyethyl methacrylate (HEMA) (3 parts by weight) and 1-methoxy-2-propanol (90 parts by weight), and exposed using an exposure apparatus (UVX-02516S1 LP01, a product of Ushio Inc.) for 1 minute. After the exposure, the surface was sufficiently washed with acetone and pure water.

Then, an opening for via hole formation was provided using carbon dioxide gas laser. Processing conditions in this case are pulse width 15/12/5 μsec, and shot number 1/1/1 (laser processing machine LCO-1B21, a product of Hitachi Via Mechanics, Ltd.).

A wiring pattern was formed with ink jet in the same manner as in Example 1. In this case, a pattern was drawn on the opening for via hole formation prepared by laser to form a conductive passage of a lower layer and an upper layer. Thus, a multilayer wiring board of Example 6 was obtained.

Wiring patterns on the multilayer wiring boards of Examples 5 and 6 were evaluated in the same methods as in Examples 1 to 4. To confirm via formation and through-hole wiring, cross section was observed using an electron microscope (s4700, a product of JEOL Ltd.). The results are shown in Table 2.

TABLE 2

| | Width | Volume | | |
|---|---|---|---|---|
| | of wiring | resistivity | | Cross- |
| | pattern | of wiring | | section |
| | (μm) | (μΩ · cm) | Adhesion | shape |
| Example 5 | 25 | 4 | No peeling | Good |
| Example 6 | 26 | 5 | No peeling | Good |

As is apparent from Table 1 and Table 2, according to the conductive pattern formation method applying the pattern formation method of the present invention, wiring patterns having fine line width could be formed in a state of good adhesion to a substrate.

1. A pattern forming method comprising: (I) a graft polymer forming step of preparing a substrate whose surface is modified with a graft polymer directly chemically bonded to a base material; (II) a particle-dispersed liquid placing step of placing droplets comprising a dispersion liquid, which comprises a liquid (dispersion medium) and particles dispersed therein, on the graft polymer-formed surface in a predetermined pattern by a droplet discharging method; and (III) a particle pattern forming step of evaporating the liquid (dispersion medium) from the droplets placed, to form a layer comprising the particles on the substrate in a predetermined pattern.

2. The pattern forming method as claimed in claim 1, wherein the graft polymer comprises at least one component selected from the group consisting of a water-repellent component, a hydrophilic component, and a component having metal affinity.

3. The pattern forming method as claimed in claim 1, wherein the graft polymer comprises a crosslinking component and at least one component selected from the group consisting of a water-repellent component, a hydrophilic component, and a component having metal affinity.

4. The pattern forming method as claimed in claim 2, wherein the graft polymer is a polymer formed by polymerization of at least one or more polymerization units selected from the group consisting of a water-repellent polymerization unit, a hydrophilic polymerization unit, and a polymerization unit having metal affinity.

5. The pattern forming method as claimed in claim 3, wherein the graft polymer is a polymer comprising a crosslinkable polymerization unit and at least one polymerization unit selected from the group consisting of a water-repellent polymerization unit, a hydrophilic polymerization unit, and a polymerization unit having metal affinity.

6. A pattern forming method comprising: (I) a graft polymer forming step of preparing a substrate whose surface is modified with a graft polymer directly chemically bonded to a base material; (II) a particle-dispersed liquid placing step of placing droplets comprising a dispersion liquid, which comprises a liquid (dispersion medium) and particles dispersed therein, on the graft polymer-formed surface in a predetermined pattern by a droplet discharging method; and (III-2) a particle pattern forming step of subjecting a region including the placed droplets to heating or ultraviolet irradiation, to fix the placed particles on the substrate.

7. The pattern forming method as claimed in claim 1, wherein the particles are conductive particles and a wiring pattern is formed by a droplet discharging method.

8. A method for forming a multilayer wiring structure, which comprises:
(A) a step of forming a first substrate having a wiring pattern, comprising: a graft polymer forming step of preparing a first substrate whose surface is modified with a graft polymer directly chemically bonded to a first base material; a conductive particle-dispersed liquid placing step of placing droplets comprising a dispersion liquid, which comprises a liquid (dispersion medium) and conductive particles dispersed therein, on the graft polymer-formed surface in a predetermined pattern by a droplet discharging method; and a wiring pattern forming step of evaporating the liquid (dispersion medium) from the droplets placed, to form a layer comprising the conductive particles on the first substrate in a predetermined pattern;
(B) a step of forming a second substrate having a wiring pattern, comprising: a graft polymer forming step of preparing a second substrate whose surface is modified with a graft polymer directly chemically bonded to a second base material; a conductive particle-dispersed liquid placing step of placing droplets comprising a dispersion liquid, which comprises a liquid (dispersion medium) and conductive particles dispersed therein, on the graft polymer-formed surface in a predetermined pattern by a droplet discharging method; and a wiring pattern forming step of evaporating the liquid (dispersion medium) from the droplets placed, to form a layer comprising the conductive particles on the second substrate in a predetermined pattern;
(C) a substrate laminating step of arranging the first substrate having a wiring pattern obtained by the step of forming a first substrate having a wiring pattern, and the second substrate having a wiring pattern obtained by the step of forming a second substrate having a wiring pattern, such that a wiring pattern-formed face of the first substrate having a wiring pattern faces a non-wiring pattern-formed face of the second substrate having a wiring pattern, and laminating the first substrate having a wiring pattern and the second substrate having a wiring pattern by an adhesive;
(D) a through-hole forming step of providing a through-hole for forming a conductive layer in the second substrate having a wiring pattern obtained by the step of forming a second substrate having a wiring pattern; and
(E) a wiring connecting step of placing a conductive material in the through-hole, to connect the wiring pattern on the first substrate having a wiring pattern and the wiring pattern on the second substrate having a wiring pattern.

9. The method for forming a multilayer wiring structure as claimed in claim 8, wherein the wiring connecting step (E) of placing a conductive material in the through-hole comprises: dropping droplets comprising a dispersion liquid comprising a liquid (dispersion medium) and conductive particles dispersed therein by a droplet discharging method, and then evaporating the liquid (dispersion medium) from the droplets.

10. The method for forming a multilayer wiring structure as claimed in claim 8, wherein in the wiring connecting step (E) of placing a conductive material in the through-hole comprises: placing the conductive material at least along a side wall of the through-hole, to connect the wiring pattern on the first substrate having a wiring pattern and the wiring pattern on the second substrate having a wiring pattern.

11. The method for forming a multilayer wiring structure as claimed in claim 8, wherein the substrate laminating step (C) is conducted between the through-hole forming step (D) and the wiring connecting step (E), and the first substrate having a wiring pattern and the second substrate having a wiring pattern are laminated such that the through-hole coincides with the position of a wiring pattern-formed region on the first substrate having a wiring pattern.

12. A method for forming a multilayer wiring structure, which comprises:
(a) a step of forming a first substrate having a wiring pattern, comprising: a graft polymer forming step of preparing a first substrate whose surface is modified with a graft polymer directly chemically bonded to a first base material; a conductive particle-dispersed liquid placing step of placing droplets comprising a dispersion liquid, which comprises a liquid (dispersion medium) and conductive particles dispersed therein, on the graft polymer-formed surface in a predetermined pattern by a droplet discharging method; and a wiring pattern forming step of evaporating the liquid (dispersion medium) from the droplets placed, to form a layer comprising the conductive particles on the first substrate in a predetermined pattern;
(b) a laminating step of laminating a second base material on a wiring pattern-formed face of the first substrate having a wiring pattern;
(c) a step of forming a second substrate having a wiring pattern, comprising: a graft polymer forming step of preparing a second substrate whose surface is modified with a graft polymer directly chemically bonded to a second base material; a conductive particle-dispersed liquid placing step of placing droplets comprising a dispersion liquid, which comprises a liquid (dispersion medium) and conductive particles dispersed therein, on the graft polymer-formed surface in a predetermined pattern by a droplet discharging method; and a wiring pattern forming step of evaporating the liquid (dispersion medium) from the droplets placed, to form a layer comprising the conductive particles on the second substrate in a predetermined pattern;
(d) a through-hole forming step of providing a through-hole for forming a conductive layer in the second substrate; and
(e) a wiring connecting step of placing a conductive material in the through-hole to connect the wiring pattern on the first substrate having a wiring pattern and the wiring pattern on the second substrate having a wiring pattern.

13. The method for forming a multilayer wiring structure as claimed in claim 12, wherein the wiring connecting step (e) of placing a conductive material in the through-hole comprises: dropping the droplets comprising a dispersion liquid comprising a liquid (dispersion medium) and conductive particles dispersed therein by a droplet discharging method; and then evaporating the liquid (dispersion medium) from the droplets.

14. The method for forming a multilayer wiring structure as claimed in claim 12, wherein in the wiring connecting step (e) of placing a conductive material in the through-hole, the conductive material is placed at least along a side wall of the through-hole, to connect the wiring pattern on the first substrate having a wiring pattern and the wiring pattern on the second substrate having a wiring pattern.

15. The method for forming a multilayer wiring structure as claimed in claim 12, wherein the through-hole forming step (d) is conducted between the graft polymer forming step and the wiring pattern forming step, in the step (c) of forming a second substrate having a wiring pattern.

16. The pattern forming method as claimed claim 6, wherein the particles are conductive particles and a wiring pattern is formed by a droplet discharging method.
